(19) United States
(12) Patent Application Publication
(10) Pub. No.: US 2013/0162853 A1
(43) Pub. Date: Jun. 27, 2013

(54) DIGITAL PHOTOGRAPHING APPARATUS AND METHOD OF CONTROLLING THE SAME

(71) Applicant: Samsung Electronics Co., Ltd., Suwon-si (KR)

(72) Inventors: Hye-jin Kim, Seoul (KR); Se-hyun Park, Seoul (KR)

(73) Assignee: SAMSUNG ELECTRONICS CO., LTD., Suwon-si (KR)

(21) Appl. No.: 13/707,821

(22) Filed: Dec. 7, 2012

(30) Foreign Application Priority Data
Dec. 21, 2011 (KR) 10-2011-0139218

(51) Int. Cl. H04N 5/232

(52) U.S. Cl. CPC H04N 5/23245
USPC 348/220.1

(57) ABSTRACT

According to a digital photographing apparatus and a method of controlling the digital photographing apparatus, contents desired by a user may be captured in various manners according to a condition of the user, and instead of individual contents of photographs and videos, overlapped photographing of identical types of contents or different types of contents may be performed to create new and various multi-contents.

### CROSS-REFERENCE TO RELATED PATENT APPLICATION

This application claims the priority benefit of Korean Patent Application No. 10-2011-0139218, filed on Dec. 21, 2011, in the Korean Intellectual Property Office, the disclosure of which is incorporated herein in its entirety by reference.

### BACKGROUND

Various embodiments relate to a digital photographing apparatus and a method of controlling the same.

With the recent supply of digital cameras, a technique of synthesizing a face image of a person in a background image or synthesizing various face images as if the images were taken together is widely spreading. In particular, a basic function of synthesizing face images taken using a digital camera, with special icons or a special background image is provided.

In addition, the demand of users for correlated or blended multi-contents of photographs and videos instead of those as individual contents is increasing.

### SUMMARY

Various embodiments include a digital photographing apparatus that is operable to take contents desired by a user in various manners according to a condition of the user, and a method of controlling the digital photographing apparatus.

According to an embodiment, a method of controlling a digital photographing apparatus includes: displaying a still image obtained according to a shutter release signal; displaying an area frame on the displayed still image for subsequent photography and an input image on the area frame; and recording the input image according to a video recording start signal.

A live view image of the input image may be displayed within the area frame.

The method may further include stopping the displaying of the displayed still image and displaying a live view image of the input image, after receiving the video recording start signal.

The method may further include: stopping the recording of the input image according to a video recording stop signal, and storing a video file of the input image, wherein information about the still image is recorded in the video file.

The method may further include reproducing the still image and reproducing a recorded video within the area frame of the still image, after selecting the video file and reproducing the recorded video.

The area frame may be set such that at least one of an operation of the area frame selected from the group consisting of movement, size adjustment, and shape change is performed on the still image.

The shutter release signal and the video recording start signal may be distinguished according to an order in which buttons respectively corresponding to the shutter release signal and the video recording start signal included in the digital photographing apparatus are pressed.

The shutter release signal may be generated by a shutter release button, and the video recording start signal may be generated by a video REC button.

The method may further include displaying another still image obtained by capturing the input image in the area frame after sensing the shutter release signal.

According to another embodiment, a method of controlling a digital photographing apparatus includes: displaying a live view video of a first input image while recording the first input image according to a video recording start signal; displaying an area frame on the displayed live view video for subsequent photography; and displaying a still image obtained according to a shutter release signal, within the displayed area frame.

The method may further include: displaying a live view image of a second input image within the area frame; stopping the displaying of the live view video according to a first shutter release signal, and performing focusing while displaying the live view image; and capturing the second input image according to a second shutter release signal.

The method may further include: stopping the recording of the first input image according to a video recording stop signal, and storing a video file of the first input image, wherein information about the obtained still image is written in the video file.

The information about the still image may comprise at least one set of information selected from the group consisting of timing information about when the still image is captured, file information corresponding to the still image, and information about the area frame.

The method may further include storing the obtained still image in connection with the video file that is being recorded.

The area frame may be set such that at least one of an operation of the area frame selected from the group consisting of movement, size adjustment, and shape change is performed on the live view video.

According to another embodiment, a method of controlling a digital photographing apparatus includes: reproducing a video; displaying an area frame on the video that is being reproduced for photographing; displaying an input image within the area frame; capturing the input image according to a predetermined photographing signal; and storing the captured input image in connection with the video.

The input image may be a live view video, and the photographing signal may be a video recording start signal.

The method may further include: ending the recording of the input image according to a video recording stop signal; and storing a recorded video file of the input image, wherein information about the recorded video is recorded in a reproduced video file of the reproduced video or information about the reproduced video is stored in the recorded video file.

The area frame may be set such that at least one of an operation of the area frame selected from the group consisting of movement, size adjustment, and shape change is performed on the video.

The input image may be a live view image, and the photographing signal may be a shutter release signal.

According to another embodiment, a method of controlling a digital photographing apparatus includes: receiving a photographing signal at least twice; and capturing at least one of a still image and a video according to the input photographing signal, wherein the capturing includes: displaying a first captured image obtained by capturing a first input image when a first photographing signal is input; displaying an area frame for capturing a second input image, on the first captured image; displaying the second input image on the area frame; and displaying a second captured image obtained by capturing the second input image within the area frame when a second photographing signal is input.

The method may further include storing the first captured image and the second captured image in connection with each other.

Each of the first captured image and the second captured image may comprise a still image or a video.

The area frame may be set such that at least one of an operation of the area frame selected from the group consisting of movement, size adjustment, and shape change is performed on the first captured image.

According to another embodiment, a digital photographing apparatus includes: a photographing signal sensing unit that receives a photographing signal at least twice; a still image photographing control unit that controls capturing of a still image according to the photographing signal; a video recording control unit that controls capturing of a video according to the photographing signal; an area frame setting unit that sets an area frame for photographing; and a display control unit that displays a first captured image obtained by capturing a first input image when a first photographing signal is input and displays an area frame that is set for capturing a second input image on the first captured image, displays the second input image on the area frame, and displays a second captured image obtained by capturing the second input image within the area frame when a second photographing signal is input.

### BRIEF DESCRIPTION OF THE DRAWINGS

The above and other features and advantages will become more apparent by describing in detail exemplary embodiments with reference to the attached drawings in which:

FIG. 1 is a schematic block diagram of a digital camera as an example of a digital photographing apparatus, according to an embodiment;

FIG. 2 is a detailed block diagram of the digital signal processor (DSP) illustrated in FIG. 1, according to an embodiment;

FIG. 3 is a flowchart illustrating a method of controlling a digital photographing apparatus, according to an embodiment;

FIGS. 4A and 4B are a flowchart illustrating a method of controlling a digital photographing apparatus, according to another embodiment;

FIGS. 5A through 5E are images illustrating a method of controlling a digital photographing apparatus, according to an embodiment;

FIGS. 6A through 6E are images illustrating a method of controlling a digital photographing apparatus, according to another embodiment; and

FIGS. 7A through 7F are images illustrating a method of controlling a digital photographing apparatus, according to another embodiment.

### DETAILED DESCRIPTION

Hereinafter, embodiments will be described in detail with reference to the attached drawings. Like reference numerals in the drawings denote like elements. As used herein, the term “and/or” includes any and all combinations of one or more of the associated listed items. Expressions such as “at least one of,” when preceding a list of elements, modify the entire list of elements and do not modify the individual elements of the list.

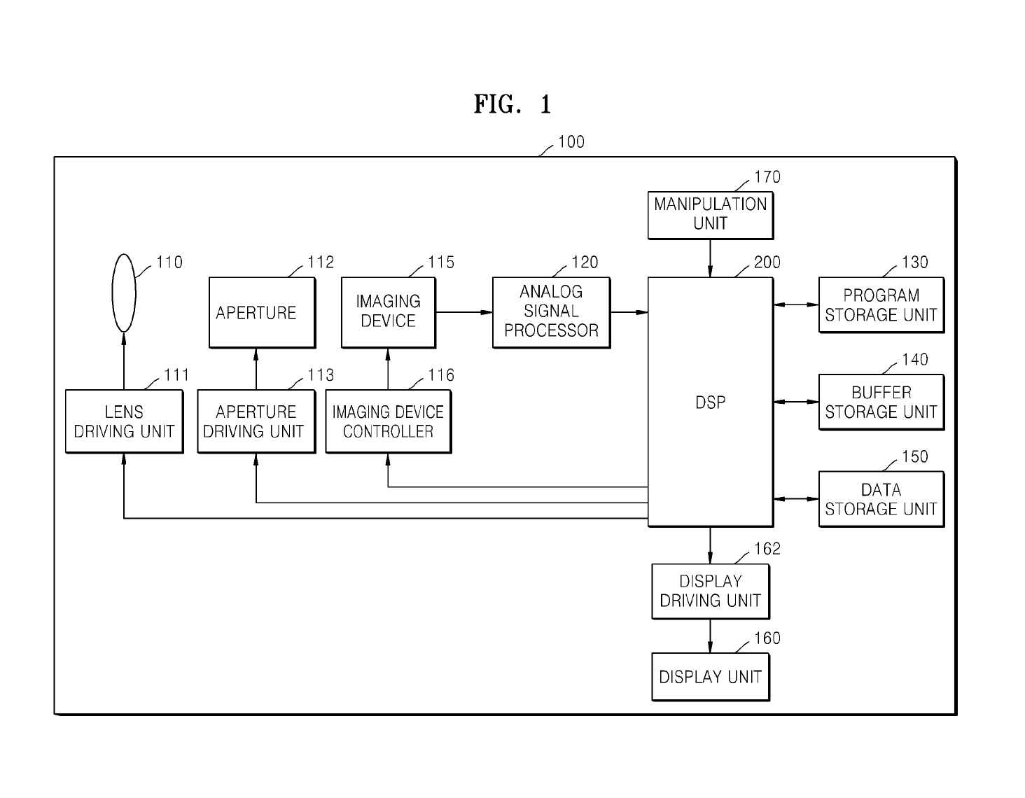

FIG. 1 is a schematic block diagram of a digital camera 100 as an example of a digital photographing apparatus, according to an embodiment.

The digital camera 100 is described below as an example of a digital photographing apparatus according to an embodiment. However, the digital photographing apparatus is not limited to the digital camera 100 of FIG. 1 and may be any of other portable apparatuses, for example, a smartphone including a camera module, a personal digital assistant (PDA), a portable multimedia player (PMP), or a camcorder.

The digital camera 100 according to the embodiment may include a lens unit 110, a lens driving unit 111, an aperture 112, an aperture driving unit 113, an imaging device 115, an imaging device controller 116, an analog signal processor 120, a program storage unit 130, a buffer storage unit 140, a data storage unit 150, a display driving unit 162, a display unit 160, a digital signal processor (DSP) 200, and a manipulation unit 170. The lens unit 110, the lens driving unit 111, the aperture 112, the aperture driving unit 113, the imaging device 115, the imaging device controller 116, and the analog signal processor 120 may be referred to as a photographing unit.

The lens unit 110 focuses an optical signal. The lens unit 110 includes a zoom lens that controls a viewing angle to be increased or decreased according to a focal length and a focus lens that adjusts a focus of an object. The zoom lens and the focus lens each may be formed of a single lens or a group of lenses. The aperture 112 adjusts an amount of incident light according to a degree of opening thereof.

The lens driving unit 111 and the aperture driving unit 113 receive a control signal from the DSP 200 and drive the lens unit 110 and the aperture 112, respectively. The lens driving unit 111 adjusts the focal length by controlling a position of a lens to perform operations of auto-focusing, zoom change, and focus change. The aperture driving unit 113 adjusts the degree of opening of the aperture 112, in particular, adjusts an f number or a value of the aperture 112 to perform operations of auto-focusing, auto-exposure correction, focus change, and adjustment of depth of field.

An optical signal passing through the lens unit 110 forms an image of a subject on a light-receiving surface of the imaging device 115. The imaging device 115 may use a charge-coupled device (CCD), a complementary metal oxide semiconductor image sensor (CIS), or a high speed image sensor that converts an optical signal to an electric signal. The imaging device controller 116 may adjust a sensitivity of the imaging device 115. The imaging device controller 116 may control the imaging device 115 according to a control signal that is automatically generated by an image signal that is input in real time or a control signal that is manually input by user manipulation. An exposure time of the imaging device 115 is adjusted by a shutter (not shown). Examples of the shutter include a mechanical shutter that adjusts incidence of light by moving a blind and an electronic shutter that controls exposure by applying an electric signal to the imaging device 115.

The analog signal processor 120 performs noise reduction processing, gain control, waveform shaping, and analog-digital conversion processing on an analog signal supplied by the imaging device 115.

The manipulation unit 170 is used to input an external control signal, for example, by a user. The manipulation unit 170 may include a shutter-release button that inputs a shutter-release signal for capturing an image by exposing the imaging device 115 to light for a predetermined period of time, a video REC button that inputs a video recording start signal and a video recording stop signal, a power button that inputs a control signal for controlling on/off of power, a wide zoom button and a tele-zoom button that increase or decrease a viewing angle according to an input, and a variety of function buttons that select a mode, for example, a text input mode, a photographing mode, a display mode, a white balance setting mode, or an exposure setting mode. The manipulation unit 170 may have a variety of types of buttons as above, but this should not be construed as limiting. For example, the manipulation unit 170 may be embodied in any type of input device, for example, a keyboard, a touch pad, a touch screen, or a remote controller, for a user to input data.

According to an embodiment, the shutter release button and the video REC button may be integrated or may be separately included. For example, when a still image is captured and a video is recorded using the shutter release button, a photographing mode may be classified as a still image photographing mode and a video recording mode. In this case, in the still image photographing mode, focusing is performed by half-pressing the shutter release button, and then capturing is performed by fully pressing the shutter release button. In the video recording mode, the shutter release button is first pressed to start recording of a video, and to stop the recording, the shutter release button is pressed again to stop the recording. If the video REC button is included, to start recording of a video, the video REC button is pressed, and to stop the recording of a video, the video REC button is pressed one more time to stop the recording of a video. Here, while predetermined buttons such as the shutter release button and the video REC button are used to perform photographing of still images and recording of videos, the embodiments should not be construed as limiting, and a predetermined interface such as a touch panel may be implemented to generate a shutter release signal, a video recording start signal, and a video recording stop signal.

The digital camera 100 includes the program storage unit 130 that stores programs such as operating systems or application systems for driving the digital camera 100, the buffer storage unit 140 that temporarily stores data needed for calculation or resultant data, and the data storage unit 150 that stores various data needed for the programs, such as an image file including an image signal or a video file.

The digital camera 100 includes the display unit 160 that displays operating states of the digital camera 100 or still image data or video data obtained by the digital camera 100. The display unit 160 may provide visual data or audio data to the user. To provide visual data, the display unit 160 may be, for example, a liquid crystal display (LCD) or an organic light-emitting display (OLED) panel. The display driving unit 162 provides a driving signal to the display unit 160. The display unit 160 according to the current embodiment is disposed on a rear surface of the digital camera 100, that is, on a surface where manipulation panels are arranged. Also, the display unit 160 may be configured to be disposed on a front surface of the digital camera 100 or on a rear surface of the digital camera 100 by default, and then to be flipped upwards from the digital camera 100 to the front surface of the digital camera 100 that may face the subject to be photographed. Also, the display unit 160 may be formed of a dual LCD that is disposed both on the rear and front surfaces of the digital camera 100.

The digital camera 100 includes the DSP 200, which processes input image signals and controls each element according to a processed input image signal or an external input signal. The DSP 200 may reduce noise of input image data and perform image signal processing for improving image quality, for example, gamma correction, color filter array interpolation, color matrix, color correction, or color enhancement. Also, the DSP 200 may generate an image file by compressing image data generated by performing the image signal processing for improving image quality, or restore image data from an image file. An image compression format may be a reversible format or an irreversible format. Compressed data may be stored in the data storage unit 150. Also, the DSP 200 may functionally perform sharpness processing, color processing, blur processing, edge emphasis processing, image interpretation processing, image recognition processing, or image effect processing. Face recognition or scene recognition processing may be performed as the image recognition processing. For example, luminance level control, color correction, contrast control, contour emphasis control, screen division processing, or character image generation and synthesis processing may also be performed.

Also, the DSP 200 may generate a control signal to control auto-focusing, zoom change, focus change, or auto-exposure correction by executing a program stored in the program storage unit 130 or using a separate module, and may provide a generated control signal to the lens unit driver 111, the aperture driving unit 113, and the imaging device controller 116, so that operations of elements, such as a shutter or a flash, of the digital camera 100 may be generally controlled.

According to an embodiment, the digital camera 100 may display on the display unit 160 a still image that is obtained according to a shutter release signal, set an area frame on the displayed still image for subsequent photography, and display an input image on the set area frame. Also, the digital camera 100 may record an input image according to a video recording start signal. That is, while displaying the captured still image as a background image, an area frame may be set, and a live view video may be displayed on the set area frame to record a video. Also, as the DSP 200 has captured a still image and displayed the same as a background image, if a video recording start signal is input, instead of the still image that is displayed previously, a live view image that is currently being recorded may be displayed on the entire screen of the display unit 160. Also, the DSP 200 may temporarily generate a video file in the data storage unit 150 according to the video recording start signal, record an input image, stop the recording of the input image according to a video recording stop signal, and store the input image in the video file. The DSP 200 stores file information of the still image that is displayed as the background in the video file or a header of the video file. When the video file is selected later and the recorded video is reproduced, a corresponding still image is imported from a memory card (not shown) based on information about the still image included in the video file and reproduced on the entire screen of the display unit 160, and the video is reproduced in the area frame where the video was recorded.

According to another embodiment, the digital camera 100 records an input image according to a video recording start signal and displays a live view image of the input image on the entire screen of the display unit 160 at the same time. In addition, the digital camera 100 displays an area frame on the displayed live view video for subsequent photography, and displays a still image obtained according to a shutter release signal within the area frame. That is, the user views a live view image while recording a video, and if the user wants to insert a still image into a predetermined area frame, or if the user wants to capture a still image at a predetermined moment, the user may capture a still image according to the live view image displayed on the set area frame of the live view video. The captured still image may be stored in connection with the video file that is being recorded. That is, after finishing the recording of the video, information corresponding to photographing timing information of the captured still image, location, size, or shape of the area frame, or information corresponding to an image file in which the still image is stored may be recorded in the video file or in a header of the video file. In addition, when the video file is selected and reproduced, the still image may be displayed together in the corresponding area frame at the capturing time of the still image based on the information of the still image. Also, the still image may not be reproduced in connection with the video but may be stored as a separate still image file in a memory card (not shown).

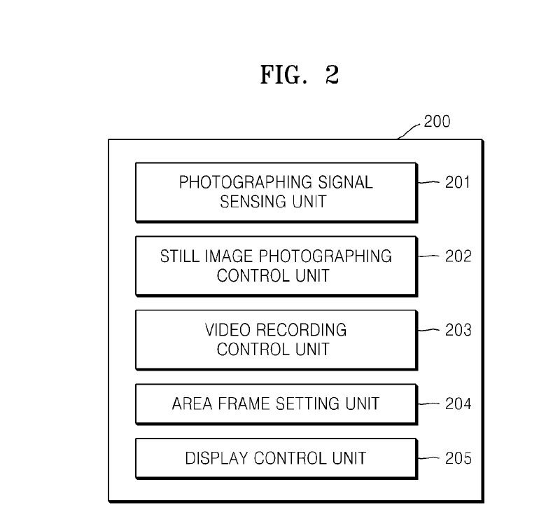

According to another embodiment, the digital camera 100 may perform overlapping video recording by reproducing the recorded video on the entire screen of the display unit 160, setting an area frame on the video that is being reproduced, and recording a video within the set area frame again. For example, an area frame may be set on the video that is being reproduced, and an input image may be displayed on the set area frame, and then when a video recording start signal corresponding to a video REC button is received from the user, recording of a video with respect to the input image is started, and a live view video is displayed within the set area frame. Here, a video file corresponding to the video that is recorded by overlapping with the background video is generated, and video file information corresponding to the overlapped video may be stored in a video file corresponding to the video that is being reproduced, or video file information corresponding to the reproduced video may be stored in a video file corresponding to the overlapped video. Description of the embodiments will be described with reference to FIG. 2.

FIG. 2 is a detailed block diagram of the DSP 200 illustrated in FIG. 1, according to an embodiment. The DSP 200 is to be understood to be an embodiment of a digital photographing apparatus described in the claims.

Referring to FIG. 2, the DSP 200 includes a photographing signal sensing unit 201, a still image photographing control unit 202, a video recording control unit 203, an area frame setting unit 204, and a display control unit 205.

The photographing signal sensing unit 201 receives a photographing signal at least twice. The photographing signal includes a shutter release signal according to a shutter release button and a video recording start signal and a video recording stop signal according to a video REC button. In addition, regardless of whether a signal is a photographing signal for a still image or a recording signal for a video, overlapping photography is performed according to the order of the received signals. For example, when a shutter release signal is input, and then a video recording start signal is input, a still image is captured as a background image, and then a video is recorded over the captured background image. In addition, when a shutter release signal is input, and then another shutter release signal is input again, a still image is captured as a background image, and then another still image is captured on the captured background image. Also, when a video recording start signal is input, and then a shutter release signal is input, a video is recorded as a background image, and a still image is captured over the background image that is being recorded.

The still image photographing control unit 202 controls capturing of a still image according to a photographing signal output from the photographing signal sensing unit 201. Capturing of a still image may be controlled according to a typical control process of a still image. For example, when a half-pressed shutter or a first shutter release signal of a shutter release signal is input on an input image or a live view image, focusing is performed around a focus area to derive a focus value, and focus control of moving a focus lens according to the derived focus value is performed. In addition, an appropriate exposure value according to the amount of incident light is controlled, and exposure control of controlling aperture values or shutter speed is performed. Then, when a fully-pressed shutter or a second shutter release signal of a shutter release signal is input, an input image is captured.

The video recording control unit 203 controls recording of a video according to a recording signal output from the photographing signal sensing unit 201. Recording of a video may be controlled according to a typical control process of video recording. For example, images input via the imaging device 115 may be sequentially stored in the buffer storage unit 140 in frame units, and processes such as video processing, interpolation processing, noise removal, luminance and color correction, resizing, or the like may be performed on the stored video data, and then the video data may be compressed by using a video encoder and stored as a video file in a memory card (not shown). Here, the video encoder encodes a YUV/RGB video format into a compression format, for example, H.264, MPEG-4, or MPEG-2 in real-time. While it has been described that the DSP 200 encodes a video by software, the described embodiments should not be construed as limiting, and encoding may also be performed with hardware. Also, control of video recording is started according to a video recording start signal, and is stopped by a video recording stop signal.

The area frame setting unit 204 sets an area frame for photographing. Here, the area frame refers to an area in which an input image is displayed in order to perform a photographing operation. Also, the area frame setting unit 204 may provide a default area frame, and when a user adjusts a location, size, or shape of the default area frame via the manipulation unit 170, the user may reset the adjusted area frame. According to the current embodiment, the area frame is set on a background image for subsequent photography, and the background image includes a still image or a video.

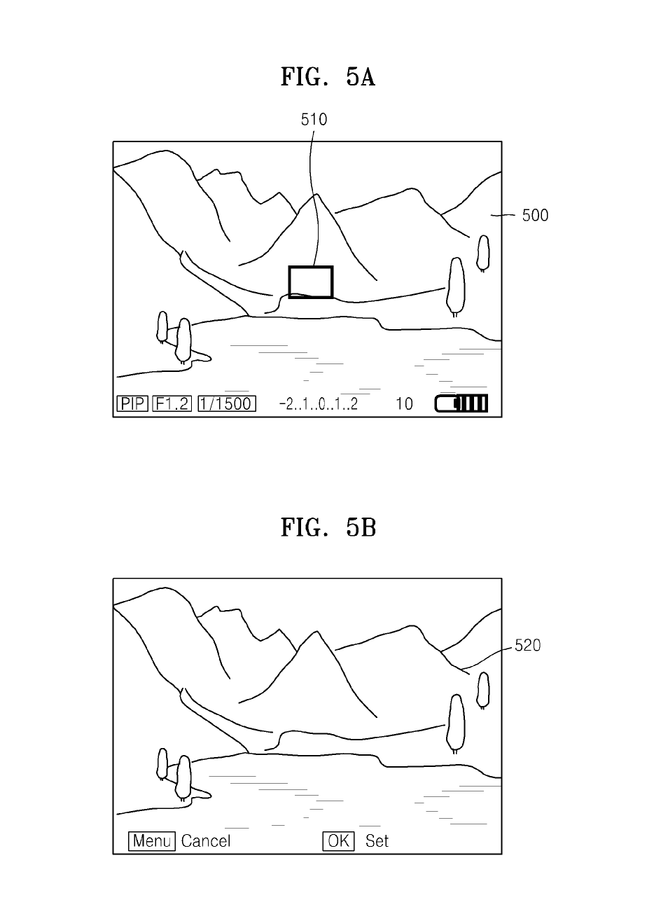

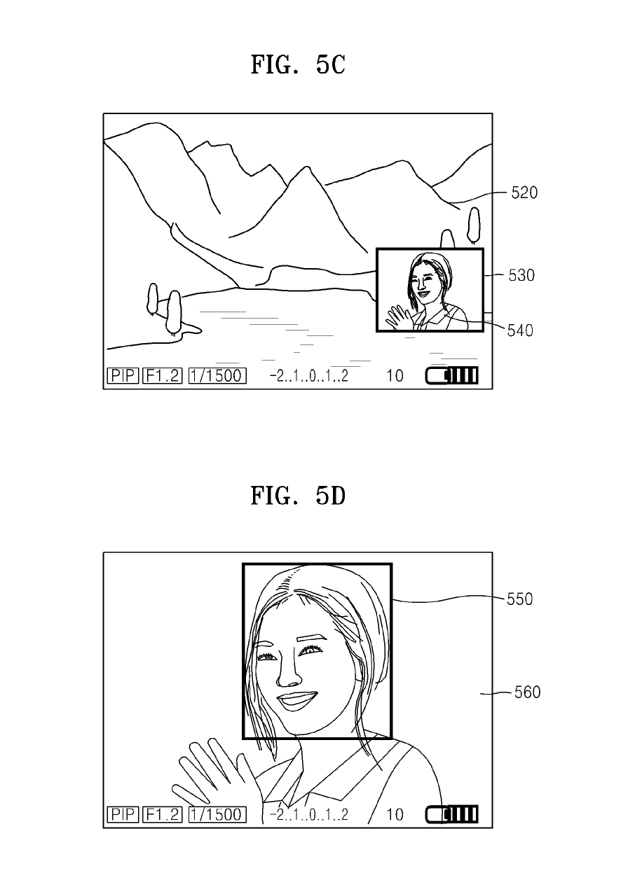

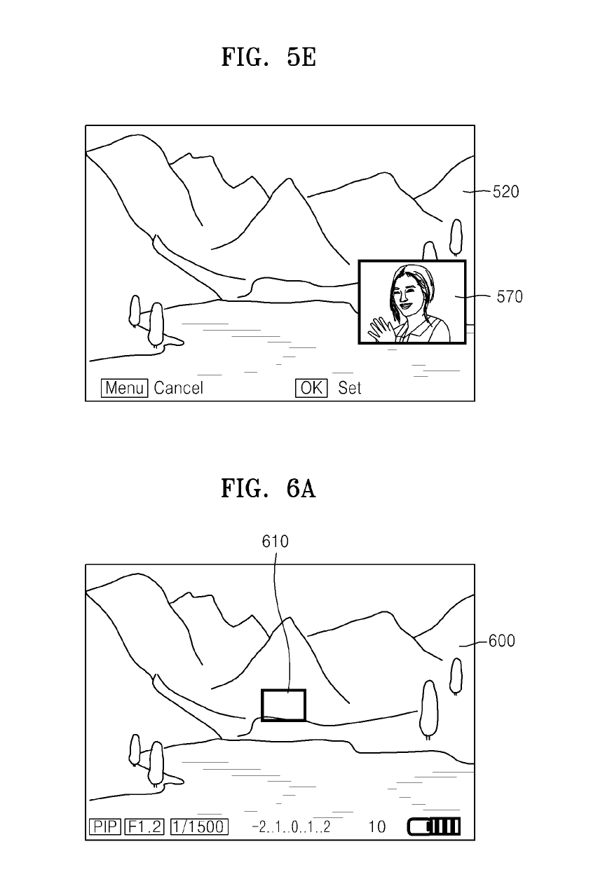

The display control unit 205 displays a first captured image obtained by capturing a first input image when a first photographing signal is input, and displays an area frame set for capturing of a second input image on the first captured image. Also, the display control unit 205 displays a second input image on the area frame, and when a second photographing signal is input, the display control unit 205 displays a second captured image obtained by capturing the second input image within the area frame. The first photographing signal may be a shutter release signal or a video recording start signal. The second photographing signal may also be a shutter release signal or a video recording start signal. The above embodiments will be described in detail with reference to FIGS. 5A through 5E, 6A through 6E, and 7A through 7F.

FIGS. 5A through 5E are images illustrating a method of controlling a digital photographing apparatus, according to an embodiment. A method of controlling capturing a still image as a background image and another still image overlapping with the still image will be described with reference to FIGS. 5A through 5E.

As illustrated in FIG. 5A, an input image 500 and an AF frame 510 for focusing are displayed. The input image 500 is a live view image. A notice message for notifying a user of overlapped photographing (e.g., “PRESS SHUTTER RELEASE BUTTON TO CAPTURE BACKGROUND IMAGE”) may be output. When a shutter release button is input, as illustrated in FIG. 5B, the input image 500 is captured, and a captured image 520 is displayed. Then, from among a setup menu illustrated in FIG. 5B, by selecting OK, an area frame 530 illustrated in FIG. 5C is displayed, and by selecting MENU again, the display screen returns to the photographing screen illustrated in FIG. 5A. As illustrated in FIG. 5C, the area frame 530 is displayed on the captured image 520, and an input image 540 is displayed within the area frame 530. In addition, a message that notifies the user of subsequent photography (e.g., “IMAGE IS CAPTURED WITHIN FRAME”, “SHUTTER: PHOTOGRAPHING”, “VIDEO REC: VIDEO RECORDING”) may be output. The input image 540 is a live view image. When a shutter is half-pressed by the user, an input image 560 formed by extending the input image 540 in the area frame 530 to the entire display screen is displayed as illustrated in FIG. 5D. Here, a face detection frame 550 may be displayed. Also, display of the captured image 520 that is captured as the background image is stopped. When the shutter is fully pressed by the user again, an image 570 that is captured over the background image 520 is displayed as illustrated in FIG. 5E. Then, when the user selects OK, the background image 520 and the captured image 570 may be synthesized and stored as a single image file, or the background image 520 and the captured image 570 may be related to each other and stored as respective image files. For example, when an image file corresponding to the background image 520 or an image file corresponding to the captured image 570 is reproduced, in order to also reproduce the image file corresponding to the captured image 570, information of one of the respective image files may be stored in its corresponding image file, a header of the one of the respective image files, or an Exif of the one of the respective image files.

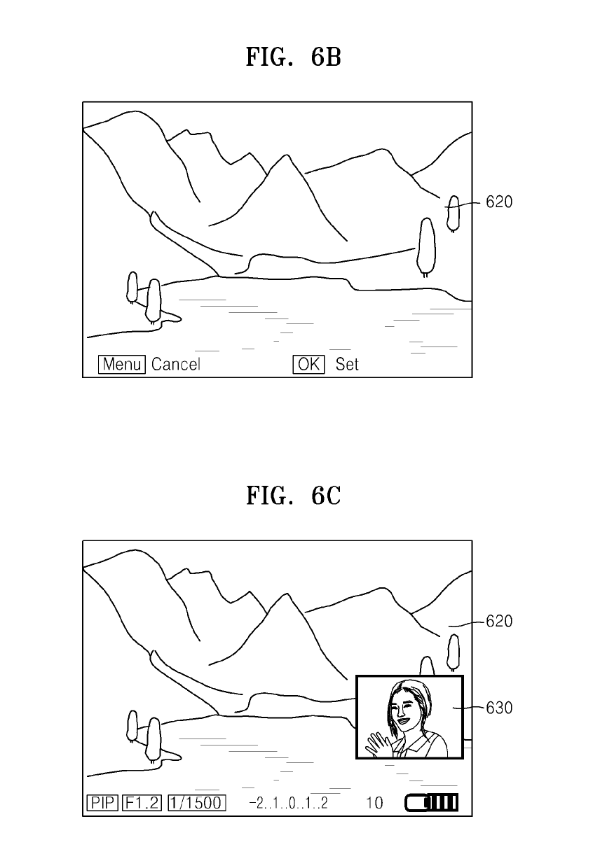

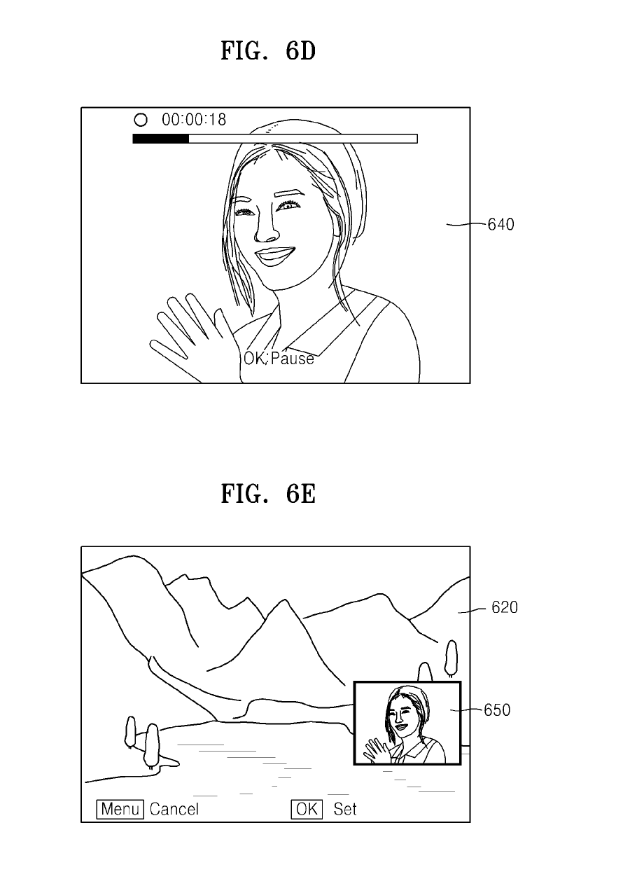

FIGS. 6A through 6E are images illustrating a method of controlling a digital photographing apparatus, according to another embodiment. A method of controlling photographing a still image as a background image and recording a video overlapping with the still image will be described with reference to FIGS. 6A through 6E.

As illustrated in FIG. 6A, an input image 600 and an AF frame 610 for focusing are displayed. The input image 600 is a live view image. A notice message for notifying a user of overlapped photographing (e.g., “PRESS SHUTTER RELEASE BUTTON TO CAPTURE BACKGROUND IMAGE”) may be output. When a shutter release button is input, as illustrated in FIG. 6B, the input image 600 is captured, and a captured image 620 is displayed. Then, from among a setup menu illustrated in FIG. 6B, by selecting OK, an area frame 630 illustrated in FIG. 6C is displayed, and by selecting MENU again, the display screen returns to the photographing screen illustrated in FIG. 6A. As illustrated in FIG. 6C, the area frame 630 is displayed on the captured image 620, and an input image 640 is displayed within the area frame 630. In addition, a message that notifies the user of subsequent photography (e.g., “IMAGE IS CAPTURED WITHIN FRAME”, “SHUTTER: PHOTOGRAPHING”, “VIDEO REC: VIDEO RECORDING”) may be output. When a video REC button is pressed by the user, the input image 640 is recorded as a video as illustrated in FIG. 6D. Referring to FIG. 6D, the display of the captured image 620 as the background image is stopped, and the live view video of recording the input image 640 is displayed on the entire screen. However, a video being recorded in the area frame 630 may also be displayed as a live view video while displaying the captured image 620 as the background image. When the video REC button is pressed again by the user, as illustrated in FIG. 6E, recording of the video is stopped, and the captured image 620 as the background image and a last frame 650 of the recorded video are displayed. Then, the recorded video file is stored. In this case, information about the captured image 620 which is a still image may be stored in the video file corresponding to the recorded video or a header of the video file, or information of corresponding video may be stored in an image file corresponding to the captured image 620.

While capturing a still image as a background image, and capturing a still image or recording a video to overlap with the above still image according to an input photographing signal has been described with reference to FIGS. 5A through 5E and 6A through 6E, a video may also be recorded as a background image, and a still image may be captured or a video may be recorded to overlap with the video according to an input photographing signal. Here, recording a video to overlap with the background image also includes reproducing a video as a background image.

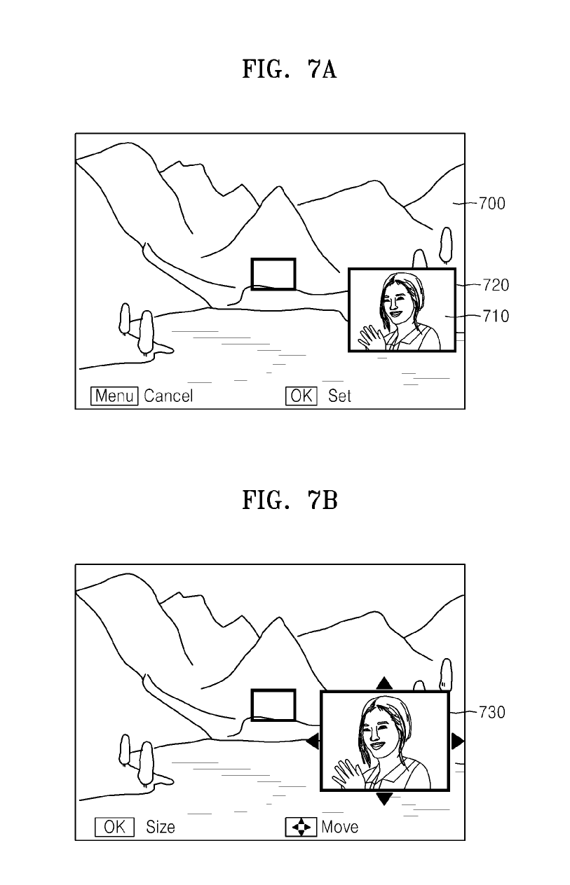

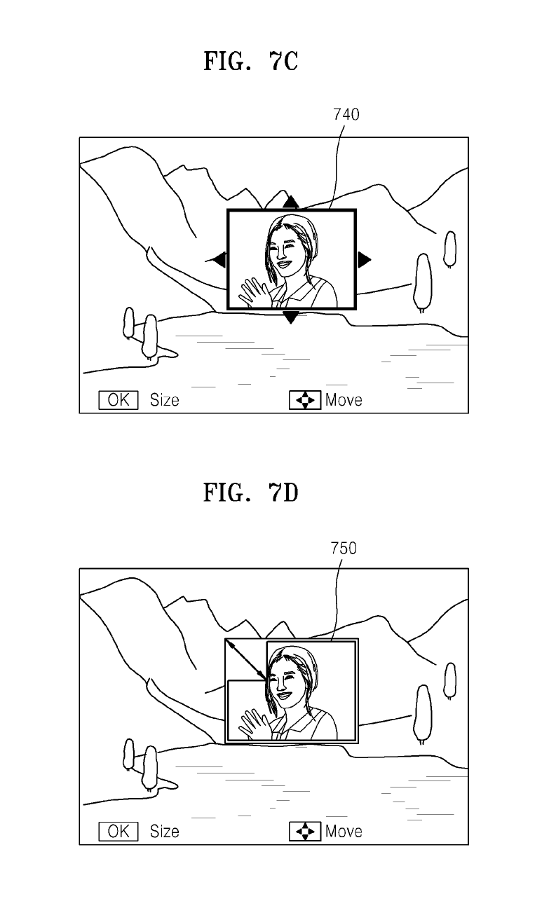

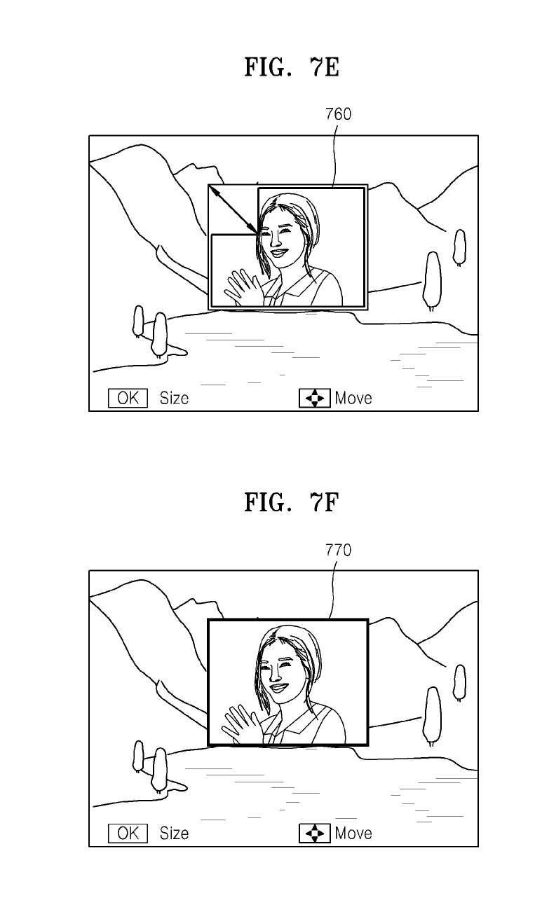

FIGS. 7A through 7F are images illustrating a method of controlling a digital photographing apparatus, according to another embodiment.

FIG. 7A illustrates an image 700 captured as a background image, an area frame 720 displayed on the image 700, and an input image 710 displayed within the area frame 720. According to a user's selection or a user's touch of the area frame 720, the size or the location of the area frame 720 varies.

As illustrated in FIG. 7B, identifiers with which an area frame 730 may be moved according to a user's selection or a touch of the area frame 730 may be displayed. As illustrated in FIG. 7C, the user may move an area frame 740 by selecting or dragging the identifiers illustrated in FIG. 7B. As illustrated in FIGS. 7D and 7E, as the user selects or drags the identifiers, a size of area frame 750 or 760 is adjusted. While change of the location of the area frames and size adjustment thereof are described with reference to FIGS. 7A through 7F, the shape of the area frames may also be changed. In addition, while the location change or size adjustment of the area frames is performed by selecting or dragging the identifiers, the processes may also be performed via other interfaces.

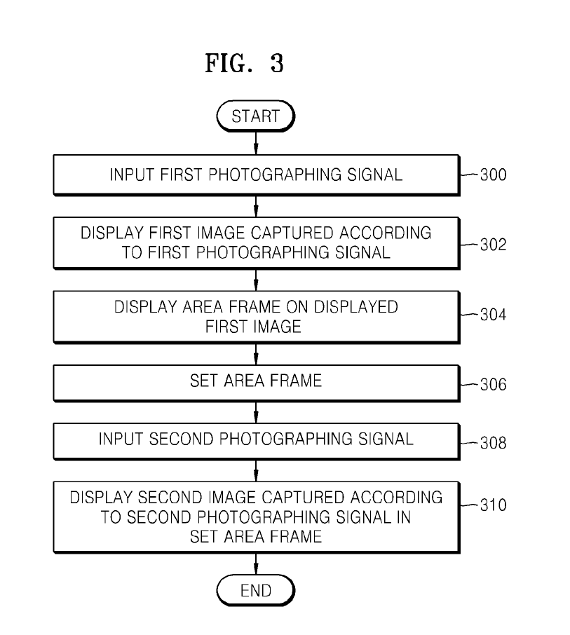

FIG. 3 is a flowchart illustrating a method of controlling a digital photographing apparatus, according to an embodiment.

Referring to FIG. 3, in operation 300, the DSP 200 receives a first photographing signal. The first photographing signal includes a shutter release signal for capturing a still image or a video recording start signal for recording a video.

In operation 302, a first image captured according to the first photographing signal is displayed. For example, if the first photographing signal is a shutter release signal for capturing a still image, a first image is a still image, and if the first photographing signal is a video recording start signal for recording a video, the first image is a live view video.

In operation 304, a display area frame is displayed on the displayed first image. That is, a display area frame for subsequent photography or overlapped photographing is displayed on the first image that is captured or being recorded as the background image in operation 302. The displayed area frame is an area frame having a predetermined location, size, and shape as default. Also, although not illustrated in FIG. 3, an image that is input for subsequent photography or overlapped photographing is displayed on the displayed area frame. The input image is a live view image.

In operation 306, an area frame is set. The area frame is set according to a user's selection. The area frame is set as described with reference to FIGS. 7A through 7F.

In operation 308, the DSP 200 receives a second photographing signal. The second photographing signal includes a shutter release signal for capturing a still image or a video recording start signal for recording a video.

In operation 310, a second image that is captured according to the second photographing signal is displayed on the set area frame. If the second photographing signal is a shutter release signal for capturing a still image, a second image is a still image, or if the second photographing signal is a video recording start signal for recording a video, the second image is a live view video.

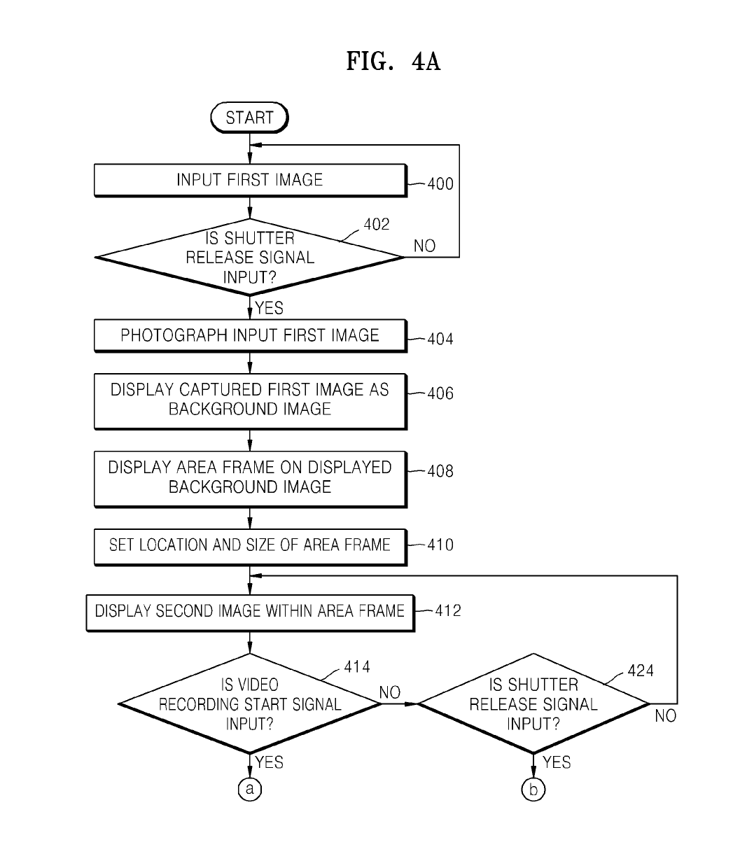

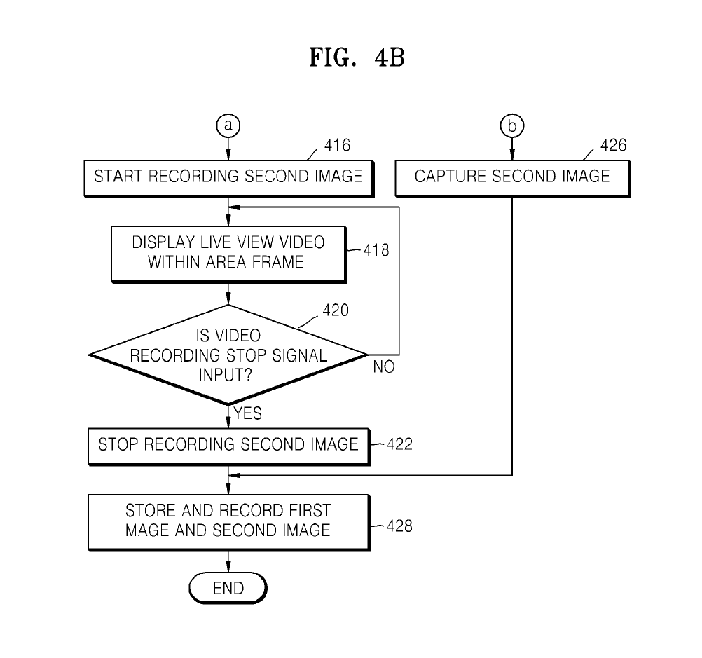

FIGS. 4A and 4B are a flowchart illustrating a method of controlling a digital photographing apparatus, according to another embodiment.

Referring to FIG. 4A, in operation 400, the DSP 200 receives a first image. The first image is a live view image.

When a shutter release signal is input in operation 402, the input first image is photographed in operation 404. The first image is captured according to the shutter release signal. Although not shown in FIG. 4, photographing control processes that are performed before capturing a still image, such as focus control or exposure control may be performed.

In operation 406, first, the captured first image is displayed as a background image. The displayed background image is a temporarily stored image as a quick view image. While the captured first image is described as a temporarily stored image, the captured first image may also be one that is stored in a memory card (not shown).

In operation 408, an area frame is displayed on the displayed background image.

In operation 410, the location and/or size of the area frame is set.

In operation 412, a second image is displayed within the area frame. The second image is an input image for overlapping photography or subsequent photography.

In operation 414, whether a video recording start signal is input or not is determined. The video recording start signal is generated when the user presses a video REC button.

When the video recording start signal is input in operation 414, recording of the second image is started in operation 416, as illustrated in FIG. 4B. The DSP 200 captures the second image according to a video recording start signal to perform the recording.

In operation 418, a live view video is displayed within the area frame set in operation 410. While the live view video is displayed in the area frame, the display of the background image of operation 406 may be stopped, and the live view video may be displayed on the whole screen.

In operation 420, whether a video recording stop signal is input or not is determined. When a video recording stop signal is input in operation 420, the recording of the video with respect to the second image is stopped in operation 422.

In operation 414, when a video recording start signal is not input, whether a shutter release signal is input or not is determined in operation 424. In operation 424, when a shutter release signal is input, the second image is captured in operation 426.

In operation 428, the first image and the second image are stored and recorded. The first image is a still image, and thus, it is stored and recorded as an image file; if the second image is a video, it is stored and recorded as a video file; and if the second image is a still image, it is stored and recorded as an image file. The file corresponding to the first image and the file corresponding to the second image may be connected to each other and stored. For example, information about the image file corresponding to the first image may be recorded in the file corresponding to the second image, or file information corresponding to the second image may be recorded in the file corresponding to the first image. Accordingly, when either the first image or the second image is reproduced, the second image or the first image may be reproduced together, respectively. While overlapped capturing of a video or a still image with a still image as a background image is described above with reference to FIGS. 4A and 4B, overlapped capturing of a still image or a video with a video as a background image may also be performed as described above.

According to the digital photographing apparatus and a method of controlling the same according to the embodiments, a user may photograph various contents as desired according to a condition of the user. Also, instead of individual contents of photographs and videos, new and various multi-contents may be generated by performing overlapping photography of identical types of contents and different types of contents.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The apparatus described herein may comprise a processor, a memory for storing program data to be executed by the processor, a permanent storage such as a disk drive, a communications port for handling communications with external devices, and user interface devices, including a display, touch panel, keys, buttons, etc. When software modules are involved, these software modules may be stored as program instructions or computer readable code executable by the processor on a non-transitory computer-readable media such as magnetic storage media (e.g., magnetic tapes, hard disks, floppy disks), optical recording media (e.g., CD-ROMs, Digital Versatile Discs (DVDs), etc.), and solid state memory (e.g., random-access memory (RAM), read-only memory (ROM), static random-access memory (SRAM), electrically erasable programmable read-only memory (EEPROM), flash memory, thumb drives, etc.). The computer readable recording media may also be distributed over network coupled computer systems so that the computer readable code is stored and executed in a distributed fashion. This computer readable recording media may be read by the computer, stored in the memory, and executed by the processor.

Also, using the disclosure herein, programmers of ordinary skill in the art to which the invention pertains may easily implement functional programs, codes, and code segments for making and using the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism”, “element”, “unit”, “structure”, “means”, and “construction” are used broadly and are not limited to mechanical or physical embodiments, but may include software routines in conjunction with processors, etc.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

What is claimed is:

1. A method of controlling a digital photographing apparatus, the method comprising:
displaying a still image obtained according to a shutter release signal;
displaying an area frame on the displayed still image for subsequent photography and an input image on the area frame; and
recording the input image according to a video recording start signal.

2. The method of claim 1, wherein a live view image of the input image is displayed within the area frame.

3. The method of claim 1, further comprising stopping the displaying of the displayed still image and displaying a live view image of the input image, after receiving the video recording start signal.

4. The method of claim 1, further comprising:
stopping the recording of the input image according to a video recording stop signal; and
storing a video file of the input image,
wherein information about the still image is recorded in the video file.

5. The method of claim 4, further comprising reproducing the still image and reproducing a recorded video within the area frame of the still image, after selecting the video file and reproducing the recorded video.

6. The method of claim 1, wherein the area frame is set such that at least one of an operation of the area frame selected from the group consisting of movement, size adjustment, and shape change is performed on the still image.

7. The method of claim 1, wherein the shutter release signal and the video recording start signal are distinguished according to an order in which buttons respectively corresponding to the shutter release signal and the video recording start signal included in the digital photographing apparatus are pressed.

8. The method of claim 1, wherein the shutter release signal is generated by a shutter release button, and the video recording start signal is generated by a video REC button.

9. The method of claim 1, further comprising displaying a second still image obtained by capturing the input image in the area frame after sensing the shutter release signal.

10. A method of controlling a digital photographing apparatus, the method comprising:
displaying a live view video of a first input image while recording the first input image according to a video recording start signal;
displaying an area frame on the displayed live view video for subsequent photography; and
displaying a still image obtained according to a shutter release signal, within the displayed area frame.

11. The method of claim 10, further comprising:
displaying a live view image of a second input image within the area frame;
stopping the displaying of the live view video according to a first shutter release signal, and performing focusing while displaying the live view image; and
capturing the second input image according to a second shutter release signal.

12. The method of claim 10, further comprising:
stopping the recording of the first input image according to a video recording stop signal; and
storing a video file of the first input image,
wherein information about the obtained still image is written in the video file.

13. The method of claim 12, wherein the information about the still image comprises at least one of a set of information selected from the group consisting of timing information about when the still image is captured, file information corresponding to the still image, and information about the area frame.

14. The method of claim 10, further comprising storing the obtained still image in connection with the video file that is being recorded.

15. The method of claim 10, wherein the area frame is set such that at least one of an operation of the area frame selected from the group consisting of movement, size adjustment, and shape change is performed on the live view video.

16. A method of controlling a digital photographing apparatus, the method comprising:
reproducing a video;
displaying an area frame on the video that is being reproduced for photographing;
displaying an input image within the area frame;
capturing the input image according to a predetermined photographing signal; and
storing the captured input image in connection with the video.

17. The method of claim 16, wherein the input image is a live view video, and the photographing signal is a video recording start signal.

18. The method of claim 17, further comprising:
ending the recording of the input image according to a video recording stop signal; and
storing a recorded video file of the input image,
wherein information about the recorded video is recorded in a reproduced video file of the reproduced video or information about the reproduced video is stored in the recorded video file.

19. The method of claim 16, wherein the area frame is set such that at least one of an operation of the area frame selected from the group consisting of movement, size adjustment, and shape change is performed on the video.

20. The method of claim 16, wherein the input image is a live view image, and the photographing signal is a shutter release signal.

21. A method of controlling a digital photographing apparatus, the method comprising:
receiving a photographing signal at least twice; and
capturing at least one of a still image and a video according to the input photographing signal,
wherein the capturing comprises:
displaying a first captured image obtained by capturing a first input image when a first photographing signal is input;
displaying an area frame for capturing a second input image, on the first captured image;
displaying the second input image on the area frame; and
displaying a second captured image obtained by capturing the second input image within the area frame when a second photographing signal is input.

22. The method of claim 21, further comprising storing the first captured image and the second captured image in connection with each other.

23. The method of claim 21, wherein each of the first captured image and the second captured image comprises a still image or a video.

24. The method of claim 21, wherein the area frame is set such that at least one of an operation of the area frame selected from the group consisting of movement, size adjustment, and shape change is performed on the first captured image.

25. A digital photographing apparatus comprising:
a photographing signal sensing unit that receives a photographing signal at least twice;
a still image photographing control unit that controls capturing of a still image according to the photographing signal;
a video recording control unit that controls capturing of a video according to the photographing signal;
an area frame setting unit that sets an area frame for photographing; and
a display control unit that displays a first captured image obtained by capturing a first input image when a first photographing signal is input, displays an area frame that is set for capturing a second input image on the first captured image, displays the second input image on the area frame, and displays a second captured image obtained by capturing the second input image within the area frame when a second photographing signal is input.
